(19) United States
(12) Patent Application Publication
(10) Pub. No.: US 2005/0022879 A1
(43) Pub. Date: Feb. 3, 2005

(54) Valve

(75) Inventors: Juergen Hess, Baden-Baden (DE); Georg Reeb, Buehl Eisental (DE)

Correspondence Address: MICHAEL BEST & FRIEDRICH, LLP, 100 E WISCONSIN AVENUE, MILWAUKEE, WI, 53202, US

(73) Assignee: Robert Bosch GmbH, Stuttgart (DE)

(21) Appl. No.: 10/837,977

(22) Filed: May 3, 2004

(30) Foreign Application Priority Data
May 12, 2003 (DE) 10321154.3

(51) Int. Cl. F16K 1/32

(52) U.S. Cl. 137/599.18

(57) ABSTRACT

The invention relates to a valve, in particular a valve for a fluid-regulated heating and/or cooling system of a motor vehicle, with a valve chamber (16), with, branching off from this, at least one inlet channel (12) and at least one outlet channel (14) as well as with a lift rod (28, 228, 328) that is movable via an actuator, and with at least one valve element (22, 222, 322) connected to the lift rod (28, 228, 328), which valve element cooperates with at least one valve seat (26, 226, 326) of the valve chamber (16) in such a way that the valve is closed in a first position of the lift rod (28, 228, 328) and is opened in a second position of the lift rod (28, 228, 328). The invention provides for at least one valve element (222, 322) to feature a pressure relief valve (242, 342).

### STATE OF THE ART

The invention starts with a valve in accordance with the species of the independent claim.

These types of valves are known for example from fluid-regulated heating or cooling systems of motor vehicles. A valve element fastened on the lift rod of the valve regulates the flow between an inlet channel and at least one outlet channel. The valve can be triggered, for example, as a function of the temperatures in the heating and/or cooling system of the motor vehicle or the passenger compartment.

Valves of this type currently still feature primarily an electromagnetic actuator, which closes the valve via an excited magnetic coil by the actuator acting on an armature connected to the lift rod of the valve. The disadvantage of this type of valve is that activating the actuator produces an abrupt closing and therefore pressure disturbances in the fluid system of the cooling circuit.

As a result, pressure peaks occur when closing the valves in heating systems in motor vehicles in which the water quantity is regulated by the cycles of the valves, because of the short closing times of the valves and the flow energy of the water. This leads, particularly in the area of commercial vehicles, to high component stress with negative effects for example also on a heat exchanger in the heating circuit. Currently known water valves for the heating and/or cooling circuit of motor vehicles are also very loud to some extent when the described switching function is exercised.

A magnetic valve for a fluid-regulated heating and/or cooling system is known from DE 197 54 257 A1, which features a supply channel and at least one discharge channel, whose mutual connection is produced by an electromagnetically switched valve element in a first switching position and blocked in a second switching position. The valve from DE 197 54 257 A1 has an elastic element in the form of a spring on its valve stem, which delays the speed of the valve stem when closing the valve element. For this purpose, the spring element is arranged between the valve element and the valve stem. Because of the elastic decoupling of lift rods and valve element, the valve element is pushed more slowly into the valve seat when closing the valve so that pressure peaks are thereby reduced and the switching noises can be suppressed.

In a second exemplary embodiment of the water valve in DE 197 54 257 A1, a damping plate is also solidly arranged on the valve stem, which moves in a dampening chamber filled with a viscous liquid. In order to modulate the dampening effect for the valve element, several throttle bores are provided in the damping plate, which determine the resistance of the damping plate vis-à-vis the viscous liquid and thereby delay the movement of the lift rod in the desired manner.

A safety valve that has a two-piece lift rod is known from U.S. Pat. No. 4,364,541. While the first part of the lift rod is connected to an actuator for the valve, the second part of the lift rod bears two valve elements that are arranged spaced apart from one another. The two parts of the lift rod in U.S. Pat. No. 4,364,541 can be displaced against one another in the axial direction of the lift rod. The relative movement of the two parts of the lift rod to one another is conveyed via an elastic spring element.

The expensive, mutual decoupling of the two portions of the lift rod is disadvantageous in the safety valve described in U.S. Pat. No. 4,364,541. In addition, the relative movement of the two portions of the lift rod in this state of the art valve must be adjusted by an additional spring element. Just like the valve in DE 197 54 257 A1, this type of valve requires expensive assembly, not the least due to the numerous individual parts. In addition, the complex arrangement of the movable parts of these valves produces increased requirements for the actuator, which, in turn, goes hand in hand with an increased weight and a greater installation volume of the valve unit.

### ADVANTAGES OF THE INVENTION

In contrast to this, the valve in accordance with the invention with the features of the main claim has the advantage that pressure peaks occurring during the closing process can be reduced by simple measures.

The valve in accordance with the invention features a valve element with a sealing cone into which a pressure relief valve is integrated. Because the pressure relief valve is integrated into the valve element, the size of the valve remains unchanged in an advantageous manner. Such a measure also has no negative effect on the response time of the valve since the mass of the valve element has not been essentially changed.

The valve element of the valve in accordance with the invention or its sealing cone is modified in this connection in such a way that when a certain pressure (limit pressure) is reached in the valve, the valve is opened, independent of the position of the valve element, and a connection between the inlet channel and the outlet channel of the valve is released. In this way, pressure compensation between the inlet channel and the outlet channel is produced in particular during the closing process of the valve. Undesired pressure peaks when quickly closing the valve are reduced or avoided in an advantageous manner.

Advantageous further developments and improvements of the valve disclosed in Claim 1 are possible due to the measures listed in the other claims.

In an advantageous manner, the pressure relief valve of the valve element is embodied in such a way that when a limit pressure is reached on the valve element, the at least one inlet channel is connected to the at least one outlet channel via the pressure relief valve.

In a first embodiment of the valve in accordance with the invention, the pressure relief valve is embodied as a spherical valve and features at least one spherical element, which opens or closes a connecting channel between the at least one inlet channel and the at least one outlet channel.

The spherical element can be pre-stressed in a simple and reliable manner by a spring element so that the connecting channel between the at least one inlet channel and the at least one outlet channel is closed for pressures below the limit pressure.

In another advantageous embodiment of the valve in accordance with the invention, the pressure relief valve is embodied in the form of a leaf spring valve.

In doing so, at least one leaf spring cooperates with at least bore hole arranged in the sealing cone of the valve element in such a way that a connection is opened or closed between the inlet channel and the outlet channel of the valve.

The lift of the at least one leaf spring is limited in this connection by a stopping element in the form of a holding plate. The holding plate also provides, in an advantageous manner, for the axial fixing of the leaf spring on the lift rod of the valve.

The use of the valve in accordance with the invention, for example, in the embodiment of an electromagnetic cycle valve for the cooling and/or heating circuit of a motor vehicle is possible with advantages as compared with corresponding state of the art valves since particularly the pressure peaks of the cycled electromagnetic actuators, which occur due to the quick closing of the valve, can be reduced.

As a result, the valve in accordance with the invention makes possible in a simple manner a clear reduction in pressure peaks and noise formation when switching the valve.

### DRAWINGS

Two exemplary embodiments of a valve in accordance with the invention are shown in the drawing, which will be explained in greater detail in the following description. The figures in the drawing, their description, as well as the claims, contain numerous features in combination. The expert will also observe these features individually and combine them into additional, meaningful combinations.

The drawings show:

FIG. 1 A cross-section through an electromagnetic cycle valve in accordance with the state of the art.

FIG. 2 A detailed view of the valve chamber of the valve in accordance with the invention with a first exemplary embodiment of a valve element.

FIG. 3 A detailed view of the valve chamber of the valve in accordance with the invention with a second exemplary embodiment of a valve element.

### DESCRIPTION OF THE EXEMPLARY EMBODIMENTS

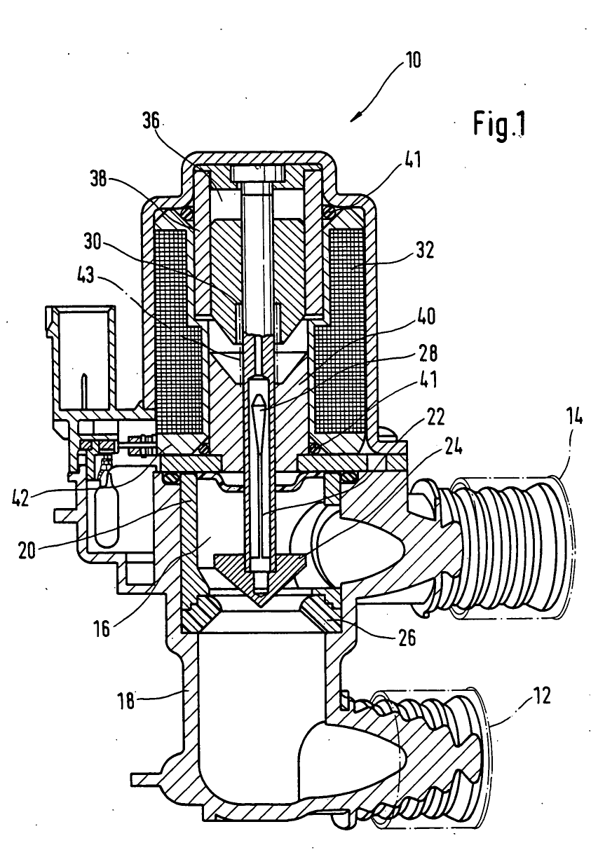

FIG. 1 shows a valve in the embodiment of a cycled magnetic valve in accordance with the state of the art. The magnetic valve 10 has an inlet channel 12 and an outlet channel 14, which are connected to one another via a valve chamber 16. A valve chamber unit 20 inserted into the valve housing 18 forms the valve chamber 16. Provided between the channels 12 and 14 is a valve element 22, which is movably arranged in the valve chamber 16 and cooperates with a valve seat 26 of the valve chamber 16 via a sealing valve cone 24. In the exemplary embodiment in FIG. 1, the valve seat 26 is embodied as an elastic ring limiting the valve chamber 16 vis-à-vis the inlet channel 12. Because of the elastic valve seat 26, the valve cone 24 of the valve element 22 in this exemplary embodiment must not necessarily also be elastic.

The sealing cone 24 of the valve element 22 is axially secured on a lift rod 28. In addition, an armature 30, which cooperates with a magnetic coil 32 and forms the electromagnetic actuator 34 of the valve 10, is fastened on the lift rod 28. The armature 30 is fed axially, displaceably through a guide bush 38 into an armature area 36 of the actuator 34.

The spring element 43 shifts the valve element 22 into its opened position so that the sealing cone 24 is lifted from the valve seat 26. In another exemplary embodiment of the valve in accordance with the invention, the prevailing fluid pressure, e.g., in a to-be-regulated heating and/or cooling circuit of a motor vehicle, which adjusts in the inlet channel 12 of the valve, can also lift the valve element 22 into its opened position.

If the magnetic coil 32 is excited, then the armature core 40, which is connected to a back yoke 42 of the actuator 34, attracts the armature 30 against the force of a valve spring 43 arranged in the armature space 36 and the fluid pressure in the inlet channel 12 and the valve element 22 closes the connection between the inlet channel 12 and the outlet channel 14 of the valve 10 by the fact that the sealing cone 24 is pressed on the valve seat 26. The magnetic coil 32 is sealed via sealing rings 41 vis-à-vis the armature area 36 and therefore against any penetrating fluid.

The disadvantage in the case of these valves according to the state of the art is that activating the actuator can lead to abrupt closing and thus pressure interference in the fluid system of the cooling circuit. As a result, in the case of heating systems in vehicles in which the water quantity is regulated by the cycles of these types of valves, pressure peaks can come about when closing the valve due to the short closing times of the valves and the flow energy of the water.

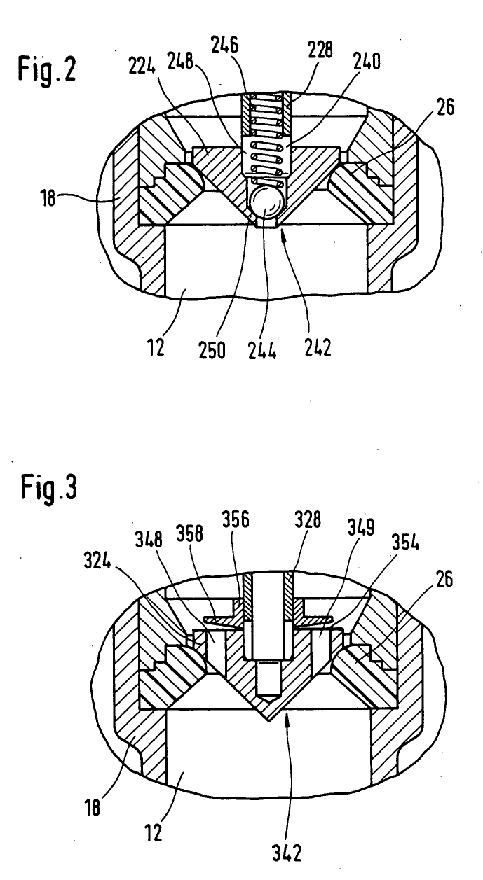

FIGS. 2 and 3 show detailed views of two exemplary embodiments of a valve in accordance with the invention. In both cases, only one part of the valve chamber is shown with the valve element and the valve seat 26. Otherwise, the following exemplary embodiments correspond to the valve described in FIG. 1.

FIG. 2 shows a first exemplary embodiment of the valve element 224 of a valve in accordance with the invention.

The valve element 222 was modified in such a way that it opens when a certain pressure on the valve is reached, in other words, a connecting channel 240 between the inlet channel 12 and the outlet channel 14 is released, although the sealing cone 224 of the valve element 222 is already situated on the valve seat 26, for example. The pressure relief function was realized in this way by a pressure relief valve 242, which is integrated into the valve element 222 in the form of a sphere 244 and a spring element 246. The valve element 222 has a continuous bore hole 248 in which the sphere 244 is loosely positioned. The spring element 246, which is supported on a limit stop in the lift rod 228, exerts a force on the sphere 244. As a result, the sphere is adjacent to an internal sealing surface 250 of the bore hole 248 of the valve element 224 and closes the bore hole 248, which normally serves as a connecting channel 240, so that the valve element 224 can close the connection between the inlet channel 12 and the outlet channel 14. Now, if the pressure on the valve element 222 exceeds a certain limit valve (limit pressure), particularly during the closing process of the valve, the sphere 244 is lifted against the force of the spring element 246 and the connecting channel 240 between the inlet channel 12 and the outlet channel 14 of the valve in accordance with the invention is opened so that a certain pressure compensation can take place. As a result of this pressure compensation, a reduction in the pressure peaks when closing the valve in accordance with the invention is achieved.

By integrating the pressure relief valve 242 into the valve element 222, the size of the valve 10 remains unchanged in an advantageous manner. In addition, this measures has no effect on the response time of the valve.

FIG. 3 shows a second exemplary embodiment of the valve element 322 of the valve in accordance with the invention.

The valve cone 324 of the valve element 322 was also modified in such a way that it opens when a certain pressure (limit pressure) on the valve is reached (independent of the position of the valve element 322) and releases a connection between the inlet channel 12 and the outlet channel 14 of the valve. The back-pressure or pressure relief valve 342 of the valve element of the second exemplary embodiment in accordance with FIG. 3 has two bore holes 348 and 349, which lead through the sealing cone 324. The bore holes 348 and 349 are covered by a sealing disk in the form a leaf spring 354. In this connection, the sealing disk 354 is connected on the side of the sealing cone 324 of the valve element 322 that faces the actuator 34. The leaf spring 354, which is preferably composed of sheet metal, but can also be manufactured of other materials, is pressed against the sealing cone 324 by a holding plate 356 and thereby fixed in its axial position. In the process, the holding plate 356 only presses the leaf spring 354 in its radial internal area near the lift rod 328 on the sealing cone 324. The holding plate 356, which is permanently connected to the lift rod 328, e.g., pressed on the lift rod, is formed in such a way that it has a certain axial distance over the sealing cone 324 in the area of the bore holes 348 and 349. In this way, it is possible for the leaf spring 354 to lift away from the bore holes 348 and 349 and release a connection between the inlet channel 12 and the outlet channel 14. At the same time, the holding plate 356 also serves as a limit stop 358, which limits the lift of the leaf spring 354.

The state of the valve, i.e., the fact whether the connection between the inlet channel 12 and the outlet channel 14 is opened or closed, is dependent upon the forces that act upon the leaf spring 354. The force ratio on the leaf spring 354 is essentially determined by the bore hole cross-section of the bore holes 348 and 349, and the surface that is covered by the leaf spring 356. In the case of an equilibrium of forces, the bore holes 348 and 349 are closed in the sealing cone 324 by the leaf spring 354. In the case of excess pressure in the inlet channel 12 of the valve in accordance with the invention, the leaf spring 354 is lifted in its radially external areas away from the sealing cone 324, however, and releases the connection. As a result, the pressure difference between the inlet channel 12 and the outlet channel 14 of the valve is reduced in an advantageous manner so that the occurrence of pressure peaks in the fluid circuit can be counteracted.

In other exemplary embodiments, a fewer or greater number of bore holes can be provided in the sealing cone, and the bore holes can also each be provided with their own leaf spring as a sealing disk, for example.

The valve in accordance with the invention is not limited to the embodiments depicted in FIGS. 1 through 3.

In particular, the valve in accordance with the invention is not limited to an embodiment as an electromagnetically activated cycle valve. Hydraulic or pneumatic actuators are also possible, for example, along with other embodiments of the valve in accordance with the invention.

The valve in accordance with the invention is also not limited to the presence of only one valve element, but can also be used in an advantageous manner for valves with, for example, two outlet channels with two corresponding allocated valves seats.

The valve in accordance with the invention is also not limited to an application in fluid-regulated heating and/or cooling systems for motor vehicles.

1. Valve, in particular for a fluid-regulated heating and/or cooling system of a motor vehicle, with a valve chamber (16), with, branching off from this, at least one inlet channel (12) and at least one outlet channel (14) as well as with a lift rod (28, 228, 328) that is movable via an actuator, and with at least one valve element (22, 222, 322) connected to the lift rod (28, 228, 328), which valve element cooperates with at least one valve seat (26, 226, 326) of the valve chamber (16) in such a way that the valve is closed in a first position of the lift rod (28, 228, 328) and is opened in a second position of the lift rod (28, 228, 328), characterized in that at least one valve element (222, 322) features a pressure relief valve (242, 342).

2. Valve according to claim 1, characterized in that the pressure relief valve (242, 342) is embodied in such a way that when a limit pressure is reached on the valve element (22, 222, 322), the at least one inlet channel (12) is connected to the at least one outlet channel (14) via the pressure relief valve (242, 342).

3. Valve according to claim 2, characterized in that the pressure relief valve (242) features at least one spherical element (244), which opens or closes a connecting channel (240) between the at least one inlet channel (12) and the at least one outlet channel (14).

4. Valve according to claim 3, characterized in that at least one spherical element (244) is pre-stressed by at least one spring element (246) in such a way that the connecting channel (240) between the at least one inlet channel (12) and the at least one outlet channel (14) is closed for pressures below the limit pressure.

5. Valve according to claim 2, characterized in that the pressure relief valve (342) is embodied in the form of a leaf spring valve (342).

6. Valve according to claim 5, characterized in that at least one sealing disk (354) cooperates with at least one bore hole (348, 349) arranged in the valve element (322) in such a way that a connection is opened or closed between the at least one inlet channel (12) and the at least one outlet channel (14).

7. Valve according to claim 5, characterized in that the lift of the at least one sealing disk (354) is limited by a stopping element (356).

8. Valve according to claim 1, characterized in that the valve possesses an electromagnetic actuator (34).

9. Valve according to claim 1, characterized in that a second outlet channel, with an associated valve seat and valve element, branch off from the valve chamber (16) of the valve.

10. Valve according to claim 6, characterized in that the lift of the at least one sealing disk (354) is limited by a stopping element (356).
